(19) United States
(12) Patent Application Publication
(10) Pub. No.: US 2006/0129863 A1
(43) Pub. Date: Jun. 15, 2006

(54) Personal computer protection device

(76) Inventors: Peter Kouropoulos, San Francisco, CA (US); Elliot Broadwin, Fremont, CA (US); Brian L. Klosterman, Pleasanton, CA (US); Andrew H. Duncan, Venice, CA (US); Larry E. Henneman JR., Three Rivers, MI (US)

Correspondence Address: HENNEMAN & SAUNDERS, 714 WEST MICHIGAN AVENUE, THREE RIVERS, MI, 49093, US

(21) Appl. No.: 11/263,548

(22) Filed: Oct. 31, 2005

Related U.S. Application Data
(63) Continuation-in-part of application No. 09/612,612, filed on Jul. 9, 2000, now Pat. No. 6,961,856.

(51) Int. Cl. G06F 1/30

(52) U.S. Cl. 713/340

(57) ABSTRACT

A personal computer protection device for disconnecting a computer system from a communications channel during power down periods. The personal computer protection device includes a power sensor for sensing power drawn by the computer system, an input port for connecting to a communications channel, an output for connecting the input port to a communications channel input of the computer system and a relay connected between the input port and output port. The relay selectively disconnects the input port and output port when the sensor senses the power drawn is below a threshold value thereby indicating the computer system is in a powered down or sleep state.

### RELATED APPLICATIONS

This application is a continuation-in-part of copending U.S. patent application Ser. No. 09/612,612 (U.S. Pat. No. 6,961,856), filed Jul. 9, 2000 by at least one common inventor, which is incorporated herein by reference in its entirety.

### BACKGROUND

1. Field of the Invention

The present invention relates generally to computers and, more specifically, to a device able to block access to communications lines connected to a personal computer at times of inactivity thus preventing others from accessing the computer without authorization.

2. Description of the Prior Art

Numerous types of protection devices for computers have been provided in the prior art. Most of these devices are software related and act to prevent others from accessing your computer through connection with an outside line such as a cable line, DSL line, modem line or phone/fax line. Protecting information contained on computers from unrestricted access through connections to outside communications channels is a high priority for most users as the amount of business performed on computers is increasing at an enormous rate.

In today's high speed, internet environment consumers are able to perform most any task over the internet such as investing, banking, shopping, etc. and most people store personal private information on their computers. Hacker's are constantly devising new methods for accessing information on anyone's computer without the alerting the affected party to the intrusion. Software and firewalls available today are able to protect personal computers to a certain extent when the computer is turned on. However, when the computer is off, the software is ineffective on intruders. Personal firewalls are also helpful in preventing intrusions however they are very expensive. While these units may be suitable for the particular purpose to which they address, they would not be as suitable for the purposes of the present invention as heretofore described.

Cable, DSL and regular modem/phone lines are always powered on. This presents a problem for PC owners connected to the internet through these communications channels. Thus, even with the most advanced software and firewall protection, an experienced hacker can still break through the security of any known protection on the market today.

These persistent network connections also pose a problem for internet service providers. In particular, each computer on the internet must be identified by a unique IP address, of which there is a finite number. As an internet service provider acquires more and more customers, the limited number of available IP addresses can pose a problem for the provider. In the past, providers could service a given number of customers with a smaller number of IP addresses, because when a customer logged off, the service provider could reassign the IP address. However, because cable modems, DSL modems, etc. maintain persistent connections, the IP addresses cannot be reassigned.

It is thus desirable to provide a personal computer protection device which is able to disconnect a personal computer from cable, DSL and regular modem/phone lines when the computer has been inactive for a period of time or has been turned off. It is further desirable to provide a personal computer protection device which is able to sense the power provided to a monitor and disconnect the computer from the cable, DSL and/or regular modem/phone lines when the monitor in a sleep mode or turned off. It is even further desirable to provide a personal computer protection device which is able to connect between a personal computer and any one or combination of cable, DSL and regular modem/phone lines and disconnect the personal computer therefrom upon sensing a predetermined condition. It is even further desirable to provide a personal computer protection device that capable of releasing an assigned IP address when one or more computers serviced by the IP address is inactive and/or not using a network connection.

### SUMMARY

The present invention relates generally to computers and, more specifically, to a device able to block access to communications lines connected to a personal computer at times of inactivity thus preventing others from accessing the computer without authorization.

A primary object of the present invention is to provide a personal computer protection device that will overcome the shortcomings of prior art devices.

Another object of the present invention is to provide a personal computer protection device which is able to disconnect a personal computer from cable, DSL and regular modem/phone lines when the computer has been turned off.

A further object of the present invention is to provide a personal computer protection device which is able to sense the power drawn by a monitor to determine if the monitor has entered a sleep mode or has been turned off.

A yet further object of the present invention is to provide a personal computer protection device wherein the device will disconnect the personal computer from the cable, DSL and regular modem/phone lines upon detecting the monitor has entered a sleep mode or has been turned off.

A still further object of the present invention is to provide a personal computer protection device including input and output ports for cable, DSL and regular modem/phone lines.

An even further object of the present invention is to provide a personal computer protection device having an additional output port for connection to a telephone or facsimile machine.

A yet further object of the present invention is to provide a personal computer protection device wherein the device will allow access to the computer for a specific preset period during the day thereby allowing the user to connect with the computer during the predetermined interval.

A still further object of the present invention is to provide a personal computer protection device wherein the sensor will trigger a relay or switch upon sensing the monitor is in a sleep mode or has been turned off.

A yet further object of the present invention is to provide a personal computer protection device able to sense the system power of a one piece processor monitor system.

An even further object of the present invention is to provide a personal computer protection device wherein the telephone and facsimile output port is operable even when the ports for the cable, DSL and regular modem/phone lines have been disconnected by the device.

A yet further object of the present invention is to provide a personal computer protection device that is simple and easy to use.

An even further object of the present invention is to provide a personal computer protection device that is economical in cost to manufacture.

An even further object of the present invention is to privide a personal computer protection device that is capable of protecting a plurality of computers on a local area network.

An even further object of the present invention is to provide a personal computer protection device that is capable of releasing an identifier (e.g., an IP address) to an internet service privider when one or more computers being protected is inactive.

Additional objects of the present invention will appear as the description proceeds.

A personal computer protection device for disconnecting a computer system from a communications channel during power down periods is described by the present invention. The personal computer protection device includes a power sensor for sensing power drawn by the computer system, an input port for connecting to a communications channel, an output port for connecting the input port to a communications channel input of the computer system and a relay connected between the input port and output port. The relay selectively disconnects the input port and output port when the sensor senses the power drawn is below a threshold value thereby indicating the computer system is in a powered down or sleep state. The device preferably includes first, second and third input ports, first, second and third corresponding output ports and first second and third relays, each relay being connected between a respective pair of input and output ports. The first input and first output are preferably cable connectors, the second input and second output are preferably xDSL connectors and the third input and third output ports are preferably telephone connectors. The device also includes a telephone/facsimile connector which is powered on at all times. A manual override switch is provided for manually triggering the relay. The sensor also triggers the relay to connect said input and output port during a predetermined period during a day thereby allowing a user to contact the computer system through the communications channel during the predetermined time of day.

In particular embodiments, a computer protection device includes a computer activity monitor for monitoring an activity level of at least one personal computer and generating an activity signal indicative of the activity level and an interrupt mechanism operative to terminate a connection with an internet service provider responsive to a particular value of the activity signal. An internet connection system includes the computer protection device in combination with a network connection to an internet service provider, a network communication device operative to communicate with the internet service provider via the network connection, and at least one personal computer capable of communicating with the internet service provider via the network communication device. The computer protection device serves as a network disconnect operative to selectively terminate the connection between the network communication device and the internet service provider responsive to an activity level of the personal computer(s).

A method for protecting one or more personal computers is also disclosed. The method includes establishing a network connection with an internet service provider, monitoring activity of the personal computer(s) communicating with the internet service provider via the network connection, and terminating the connection with the internet service provider if the personal computer becomes inactive. The method can be implemented in a network communications device (e.g., a cable modem, a DSL modem, etc.) with an electronically-readable medium having code embodied therein for causing the network communications device to perform the methods of the present inventions

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWING FIGURES

Various other objects, features and attendant advantages of the present invention will become more fully appreciated as the same becomes better understood when considered in conjunction with the accompanying drawings, in which like reference characters designate the same or similar parts throughout the several views.

FIG. 1 is a top perspective view of the personal computer protection device of the present invention;

FIG. 2 is a front view of the personal computer protection device of the present invention;

FIG. 3 is a top view of the personal computer protection device of the present invention;

FIG. 4 is a bottom view of the personal computer protection device of the present invention;

FIG. 5 is a block diagram illustrating the elements forming the personal computer protection device of the present invention for sensing the power drawn by a monitor;

FIG. 6 is a block diagram showing the elements of the personal computer protection device of the present invention for connection to a one piece computer system including processor and monitor in a single unit;

FIG. 7 is a block diagram showing an internet connection system using a computer protection device of the present invention as a network disconnect;

FIG. 8 is a block diagram showing an internet connection system for multiple computers;

FIG. 9 is a block diagram showing an alternate internet connection system for multiple computers;

FIG. 10A is a block diagram showing a network disconnect suitable for use in the systems of FIGS. 7-9;

FIG. 10B is a block diagram showing an alternate network disconnect suitable for use in the systems of FIGS. 7-9;

FIG. 11 is a block diagram of an internet connection system employing an internet service provider communication device with a built-in network disconnect;

FIG. 12 is a block diagram of the internet service provider communication device of FIG. 11; and

FIG. 13 is a flow chart summarizing a method for protecting one or more computers according to the present.

### DESCRIPTION OF THE REFERENCED NUMERALS

Turning now descriptively to the drawings, in which similar reference characters denote similar elements throughout the several views, the Figures illustrate the personal computer protection device of the present invention. With regard to the reference numerals used, the following numbering is used throughout the various drawing figures.

| | |
|---|---|
| 10 | personal computer protection |
| | device of the present invention |
| 12 | housing |
| 14 | top side |
| 16 | front side |
| 18 | cable connector |
| 20 | xDSL connector |
| 22 | modem line connector |
| 24 | AC outlet |
| 26 | line power override switch |
| 28 | AC power switch |
| 30 | indicator light |
| 32 | another side of the housing |
| 34 | power cord |
| 36 | second side of the housing |
| 38 | cable output connector |
| 40 | xDSL output connector |
| 42 | modem line connector |
| 44 | phone/fax connector |
| 46 | AC power supply |
| 48 | power sensor |
| 50 | first relay |
| 52 | second relay |
| 54 | third relay |
| 56 | computer system |
| 58 | microprocessor of computer system |
| 60 | memory |
| 70 | internet connection system |
| 72 | network disconnect |
| 72A | alternate network disconnect |
| 74 | ISP communication device |
| 74A | alternate ISP communication device |
| 76(1-n) | computer(s) |
| 78 | internet service provider (ISP) |
| 80 | activity monitor connection |
| 82 | network connection |
| 84 | alternate internet connection system |
| 86 | router |
| 86A | alternate router |
| 88(1-n) | interrupt device(s) |
| 90(1-n) | power cord |
| 92 | alternate internet connection system |
| 102 | activity monitor interface |
| 104 | activity signal logic |
| 106 | network media relay |
| 106A | power switch |
| 108 | time manager |
| 110 | power input |
| 112 | power outlet |
| 114 | processing unit |
| 116 | local network interface |
| 118 | ISP network interface |
| 120 | activity monitor interface |
| 122 | time management module |
| 124 | data and control logic |
| 126 | bus |
| 128 | method |
| 130 | establish connection step |
| 132 | begin monitoring activity step |
| 134 | computer active? decision step |
| 136 | terminate connection step |
| 138 | establish/maintain connection step |

### DETAILED DESCRIPTION

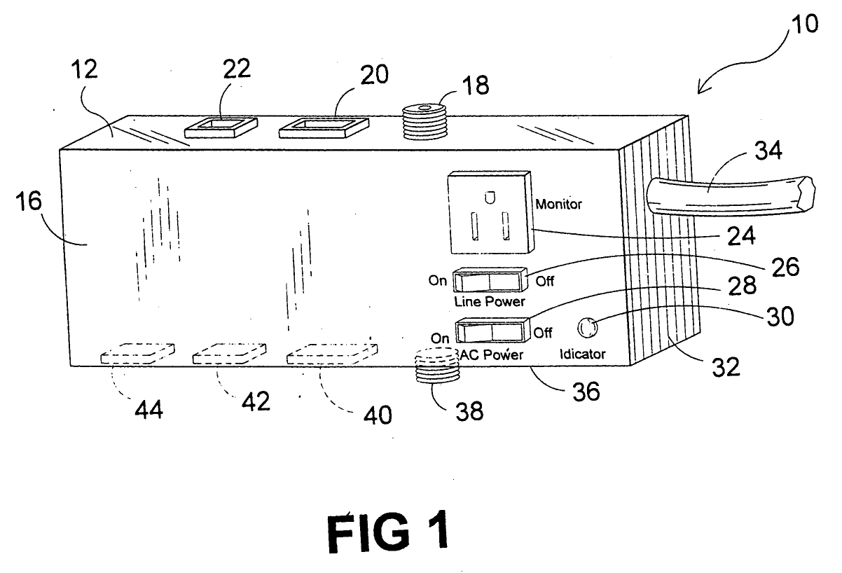

Turning now descriptively to the drawings, in which similar reference characters denote similar elements throughout the several views, FIGS. 1 through 6 illustrate the personal computer protection device of the present invention indicated generally by the numeral 10.

The personal computer protection device 10 is shown in FIG. 1 and includes a housing 12. From this view, a first side 14 and top side 16 of the housing 12 are clearly visible. The first side 14 includes a cable input connector 18 for connection with a cable line, a xDSL input connector 20 for connection with a high speed DSL line and a modem line connector 22 for connection with a telephone line.

On the top side 16 are an AC outlet 24 for a computer monitor, a line power override switch 26 and an AC power switch 28. The AC outlet 24 is provided for connection to a monitor of a computer (not shown) for supplying power to the monitor and sensing the amount of power being drawn by the monitor. The line power switch 26 is provided for manually disconnecting the cable connector 18, xDSL connector 20 and modem line connector 22 from an output thereof. The AC power switch 28 switches the personal computer protection device 10 between the on and off modes. An indicator light 30 provides a visual indication to a user that the personal computer protection device 10 is in the on mode when illuminated.

Extending from another side 32 of the housing 12 is a power cord 34 for connection to an AC power source. Shown in phantom on a second side 36 of the housing are a cable output connector 38 for connection with a cable input port of a computer, a xDSL output connector 40 for connection with a DSL input connector of a computer and a modem line connector 42 for connection with a modem line input of a computer. A telephone/fax connector 44 is also provided on the second side 36.

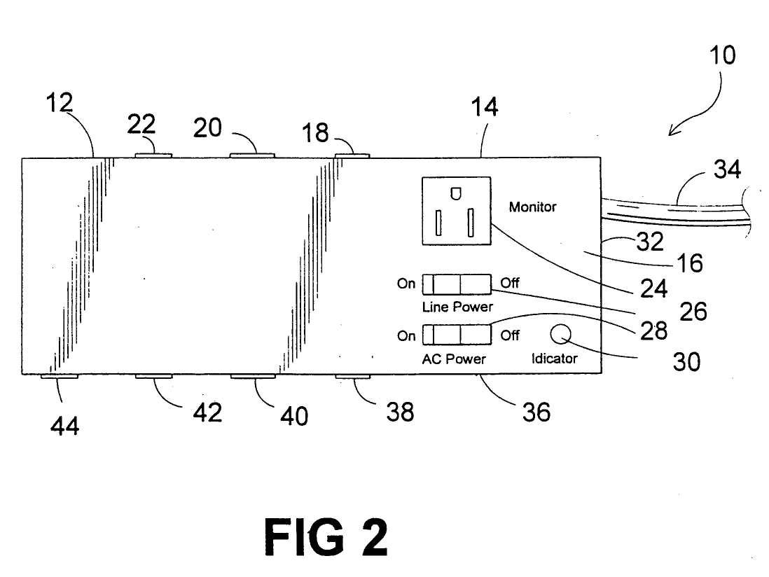

A top view of the personal computer protection device 10 is shown in FIG. 2. From this view, the top side is clearly shown. On the top side are provided the AC outlet 24 for connection with and providing power to a computer monitor, a line power override switch 26 and an AC power switch 28. The line power override switch 26 disconnects the cable input 18 from the cable output 38, the XDSL input 20 from the xDSL output 40 and the modem input 22 from the modem output 42. The AC power switch is movable between an on position supplying power to the monitor and an off position disconnecting the supply of power to the monitor. The indicator light 30 provides a visual signal indicating the mode of operation of the personal computer failsafe protection device 10. On the first side 14 are provided the cable input connector 18, xDSL input connector 20 and modem line connector 22. On the second side 36 are the cable output connector 38, xDSL output connector 40, a modem line connector 42 and the telephone/fax connection 44 for connection with an external phone or fax machine. The AC power cord is shown extending from one side 32 for supplying power to the personal computer protection device 10 and all components connected thereto.

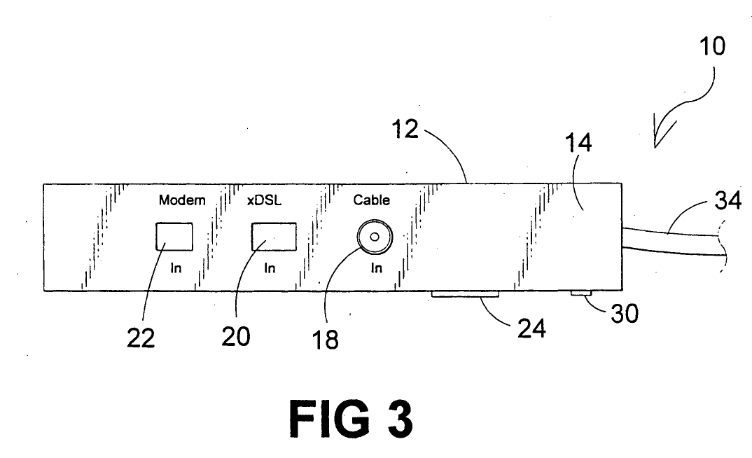

The first side 14 of the housing 12 of the personal computer protection device 10 is shown in FIG. 3. This view shows the cable input connector 18, xDSL input connector 20 and modem line connector 22. On the top side 16, the AC outlet 24 for connection to the monitor and the indicator light 30 are shown extending therefrom. The AC power cord 34 is shown extending from the side of the housing 12.

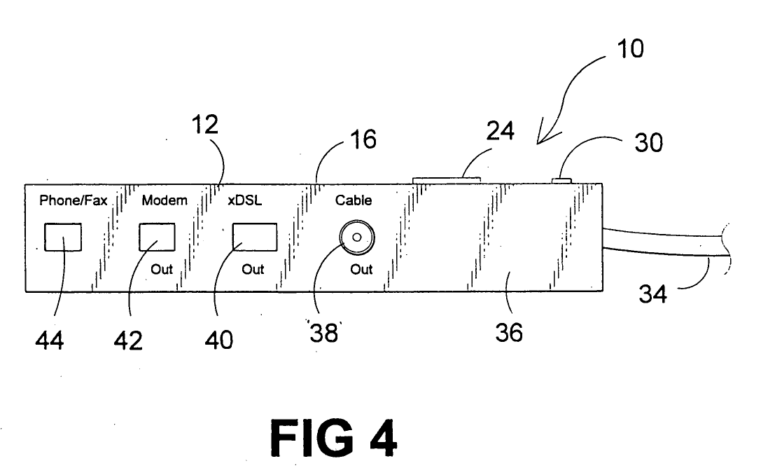

The second side 36 of the housing 12 of the personal computer protection device 10 is shown in FIG. 4. This view shows the cable output connector 38, xDSL output connector 40, modem line output connector 42 and the telephone/fax connector 44. On the top side 16, the AC outlet 24 for connection to the monitor and the indicator light 30 are shown extending therefrom. The AC power cord 34 is shown extending from the side of the housing 12.

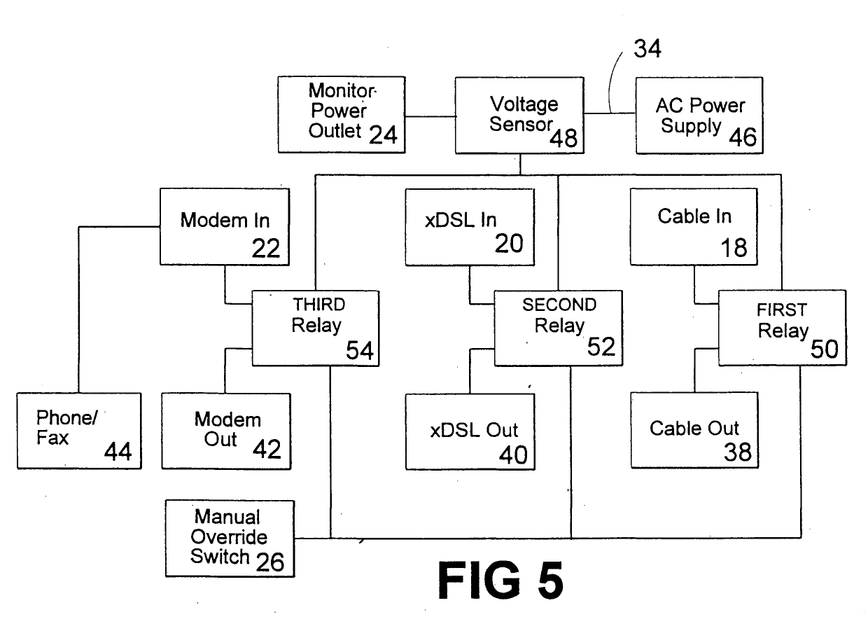

A block diagram of the personal computer protection device 10 used to sense the power usage of a monitor is shown in FIG. 5. As can be seen from this figure, The AC outlet for the monitor is connected to a power supply 46 via a power sensor 48. The power sensor 48 senses the amount of power being drawn by a monitor connected to receive power from the AC power supply 46. The power sensor 48 is connected to a first relay 50, a second relay 52 and a third relay 54. The first relay 50 is connected between the cable input connector 18 and the cable output connector 38. The second relay 52 is connected between the xDSL input 20 and the xDSL output 40. The third relay is connected between the modem input port 22 and the modem output port 42. The manual override switch 26 is also coupled to the first, second and third relays 50, 52 and 54, respectively. The first relay 50 is triggered by the power sensor 48 to disconnect the cable input connector 18 and the cable output connector 38 upon sensing the monitor is drawing power below a predetermined threshold power. The second relay 52 is triggered by the power sensor 48 to disconnect the xDSL input 20 and the xDSL output 40 upon sensing the monitor is drawing power below a predetermined threshold power. The third relay 54 is triggered by the power sensor 48 to disconnect the modem input port 22 and the modem output port 42 upon sensing the monitor is drawing power below a predetermined threshold power. The manual override switch 26 causes the first, second and third relays 50, 52 and 54, respectively, to be triggered upon activation to disconnect the input ports from the output ports. The telephone/fax port 44 is connected to the telephone line via the modem input port 22 and is operational at all times. The operation of the telephone/fax port is not controlled by triggering of the third relay switch 54.

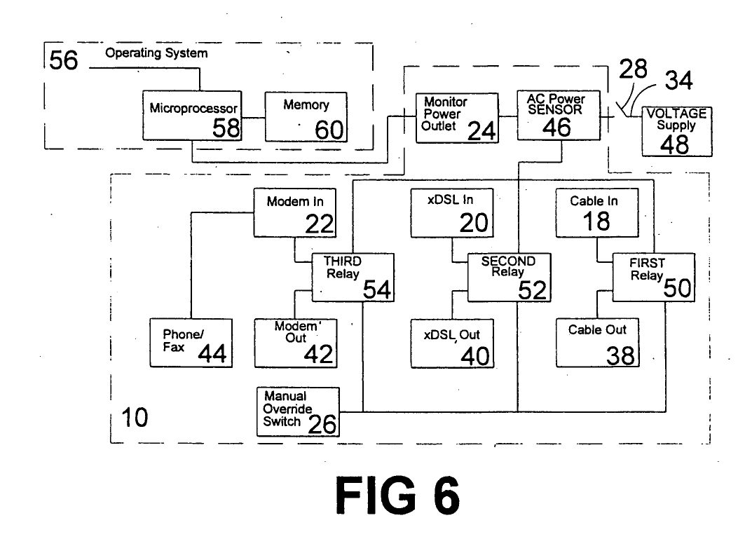

A block diagram of the personal computer protection device 10 used to monitor the power drawn by a one piece computer system 56 is illustrated in FIG. 6. As can be seen from this figure, the AC power supply 46 is connected to supply power to the personal computer failsafe protection device 10 through the power cable 34. The power sensor 48 is connected between the power cable 34 and the AC power outlet 24. A processor 58 of the one piece computer system 56 is connected to receive power through the AC power outlet 24. The microprocessor 58 is connected to a memory 60 and to the other operational elements of the one piece computer system 56. The power sensor 48 senses the amount of power being drawn by the one piece computer system 56. The power sensor 48 is connected to the first relay 50, second relay 52 and third relay 54. The first relay 50 is connected between the cable input connector 18 and the cable output connector 38. The second relay 52 is connected between the xDSL input 20 and the xDSL output 40. The third relay 54 is connected between the modem input port 22 and the modem output port 42. The manual override switch 26 is also coupled to the first, second and third relays 50, 52 and 54, respectively. The first relay 50 is triggered by the power sensor 48 to disconnect the cable input connector 18 and the cable output connector 38 upon sensing the one piece computer system 56 is drawing power below a predetermined threshold power. The second relay 52 is triggered by the power sensor 48 to disconnect the xDSL input 20 and the xDSL output 40 upon sensing the one piece computer system 56 is drawing power below a predetermined threshold power. The third relay 54 is triggered by the power sensor 48 to disconnect the modem input port 22 and the modem output port 42 upon sensing the one piece computer system 56 is drawing power below a predetermined threshold power. The manual override switch 26 causes the first, second and third relays 50, 52 and 54, respectively, to be triggered upon activation to disconnect the input ports from the output ports. The telephone/fax port 44 is connected to the telephone line via the modem input port 22 and is operational at all times. The operation of the telephone/fax port is not controlled by triggering of the third relay switch 54.

The operation of the personal computer protection device 10 will now be described with reference to the figures. In operation, the personal computer protection device 10 is connected to a monitor of a computer system or to a one piece computer system 56 for measuring the amount of power being drawn thereby. The personal computer protection device 10 receives the power cord from either the monitor or the one piece computer system 56 at the AC power outlet 24. Any desired communication channel, cable, xDSL, modem, etc. is then connected to its respective input port in the personal computer protection device 10. A cable is then connected to the output port corresponding to the desired form of communications channel to be used. The other end of the cable is connected to the corresponding communications port of the computer system or one piece computer system 56. The power cord 34 is then connected to a power supply 46 and the personal computer protection device 10 is ready for operation.

In operation, the power switch 28 is turned to the on position placing the personal computer protection device 10 in an operating mode. The computer system and monitor or one piece computer system 56 are also placed in an on mode. The power sensor 48 continually senses the power being supplied to the monitor or one piece computer system 56 to determine when the power being drawn by the computer system and monitor or one piece computer system 56 is less than a predetermined value.

When the monitor remains inactive for a predetermined period of time, the monitor will enter a sleep mode. In the sleep mode, the power required to power the monitor decreases to a minimal amount thus saving energy when the monitor is not in use. Furthermore, when the power to the monitor or one piece computer system 56 is turned off, the voltage used thereby is minimal. During each of these instances, the lines of communication, e.g. cable line, xDSL line and modem lines, are still powered up due to power present on the communications channel. At this time, a hacker is able to break into the computer system through these communications channels due to the power present on the communications channel. In order to prevent the possibility of hackers breaking into the computer system when the monitor or computer are powered down or in an idle/sleep state, the input ports to the computer system must be isolated from the system.

When the power sensor 48 senses the power drawn by the monitor or one piece computer system 56 has dropped below a threshold level such as during a sleep state or power down of the system, the power sensor will activate the first, second and third relays 50, 52 and 54, respectively, to be triggered. Triggering of the first relay causes the cable input connector 18 to be disconnected from the cable output connector 38 thereby isolating the computer system from the cable line. Triggering of the second relay 52 causes the xDSL input connector 20 to be disconnected from the xDSL output connector 40 thereby isolating the computer system from the xDSL line. Triggering of the third relay 54 causes the modem input port 22 to be disconnected from the modem output port 42 thereby isolating the computer system from the modem line. The telephone/fax line 44 will remain connected to the telephone line at all times.

Alternatively, the user is able to manually disconnect the computer system from the communications channels by activating the manual override switch 26. The manual override switch 26 is connected to the first, second and third relays and triggers each upon activation. Upon triggering by the manual override switch 26, the first relay causes the cable input connector 18 to be disconnected from the cable output connector 38 thereby isolating the computer system from the cable line, the second relay 52 causes the xDSL input connector 20 to be disconnected from the xDSL output connector 40 thereby isolating the computer system from the xDSL line and the third relay 54 causes the modem input port 22 to be disconnected from the modem output port 42 thereby isolating the computer system from the modem line.

When the power sensor 48 senses that the power being drawn by the monitor or the one piece computer system 56 moves above the threshold level, the first, second and third relays 50, 52 and 54, respectively, are triggered again. When triggered, the first relay will reconnect the cable input connector 18 and the cable output connector 38 thereby reconnecting the computer system and the cable line, the second relay 52 causes the xDSL input connector 20 to be reconnected to the xDSL output connector 40 thereby reconnecting the computer system and the xDSL line and the third relay 54 causes the modem input port 22 to be reconnected to the modem output port 42 thereby reconnecting the computer system and the modem line.

The power sensor 48 is able to trigger the first, second and third relays 50, 52 and 54, respectively, to connect the cable, xDSL and/or modem lines to the computer system or one piece processor monitor system during a predetermined time period during the day to allow a user access to the computer system or one piece processor monitor system. Thus, a user is able to connect with his computer system at a predetermined time which is unknown to others to retrieve data stored in the computer system. Upon expiration of the time period, the power sensor 48 retriggers the first, second and third relays 50, 52 and 54, respectively, to disconnect the cable, xDSL and/or modem lines from the computer system or one piece processor monitor system.

From the above description it can be seen that the personal computer protection device of the present invention is able to overcome the shortcomings of prior art devices by providing a personal computer protection device which is able to disconnect a personal computer or a one piece processor monitor system from cable, DSL and regular modem/phone lines when the computer has been turned off by sensing the voltage at a monitor to determine if the monitor has entered a sleep mode or has been turned off and disconnecting the personal computer from the cable, DSL and regular modem/phone lines upon detecting the monitor has entered a sleep mode or has been turned off. The personal computer protection device includes input and output ports for cable, DSL and regular modem/phone lines and an additional output port for connection to a telephone or facsimile machine which is operable even when the ports for the cable, DSL and regular modem/phone lines have been disconnected by the device. The personal computer device allows access to the computer for a specific preset period during the day thereby allowing the user to connect with the computer during the predetermined interval. Furthermore, the personal computer protection device of the present invention is simple and easy to use and economical in cost to manufacture.

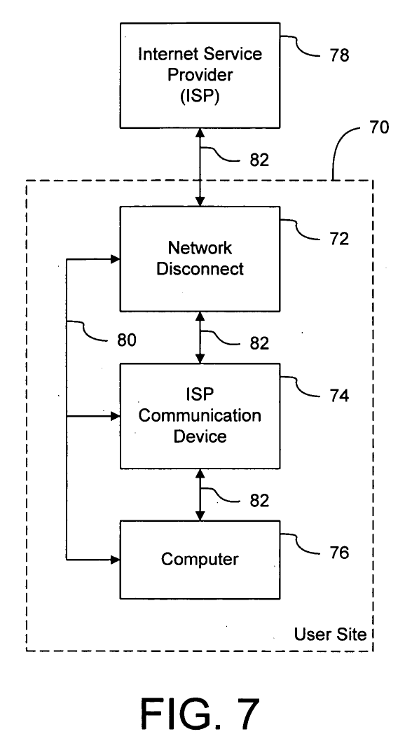

FIG. 7 is a block diagram of an internet connection system 70 using a computer protection device of the present invention as a network disconnect 72. Internet connection system 70 further includes an internet service provider (ISP) communication device 74 and a personal computer 76. ISP communication device 74 is a network communication device, for example, a DSL modem, a cable modem, a satellite transponder, or the like, that establishes a network connection with an internet service provider 78, thereby providing internet access to computer 76. Personal computer 76 represents a desktop computer, a laptop computer, or any other type of electronic device that accesses the internet through ISP communication device 74. Network disconnect 72 terminates the connection between ISP communications device 74 and ISP 78, depending on the activity level of computer 76, thereby preventing unauthorized access of computer 76 via the internet.

According to one common method for establishing a connection between ISP communications device 74 and ISP 78, ISP 78 assigns a dynamic IP (internet protocol) address to ISP communication device 74. Thereafter, ISP communications device 74 uses the assigned IP address to transmit and receive messages over the internet according to standard network protocols. When the connection is terminated, ISP 78 may then assign the IP address previously assigned to ISP communications device 74 to another customer. If ISP communications device 74 reestablishes a connection with ISP 78, then ISP 78 will assign a new, most likely different, IP address to ISP communications device 74. Because the IP address assigned to ISP communication device 74 can change each time the connection is reestablished with ISP 78, the IP address is referred to as dynamic.

In addition to preventing unauthorized access of computer 76 via the internet, terminating the network connection with ISP 78 releases the dynamic IP address assigned by ISP 78 to ISP communication device 74. This provides an important advantage to internet service providers, because each computer on a network must be identified by a unique IP address and there are only a finite number of such addresses. Specific ways of terminating the network connection with ISP 78 will be described in greater detail below.

Network disconnect 72 monitors activity on computer 76 via a connection 80. Connection 80 can be any type of connection capable of communicating indicia of activity of computer 76. For example, as shown in previous embodiments (e.g., FIGS. 1-6), activity of a computer is monitored by monitoring power consumption. Thus, in that example, connection 80 corresponds to AC outlet 24 and the power cord of the computer/monitor. As another example, connection 80 can be a communications link (e.g., wireless connection, wired connection, network cable, and so on) that provides communication between applications running on computer 76 and/or network disconnect 72. As yet another option, even though they are shown as separate paths in FIG. 7, connection 80 can be established over the same network connection 82 that provides internet access to computer 76.

Any suitable means for monitoring activity on computer 76 can be used in conjunction with the present invention. For example, known means exist for monitoring user input (e.g., keyboard activity, mouse activity, etc.) to computer 76, such as those used in computer power management schemes. As another example, a motion sensor can be employed to determine whether a user is seated at computer 76. As yet another example, software on computer 76 can monitor running applications to determine whether such applications require internet access. As yet another example, as indicated above, activity can be monitored by monitoring power consumption by computer 76. As even yet another example, computer 76 and/or ISP communication device 74 can monitor network traffic on connection 82 to determine whether computer 76 is actively using network connection 82. Any of these means or other means now known or yet to be developed can be used to generate indicia of activity of computer 76.

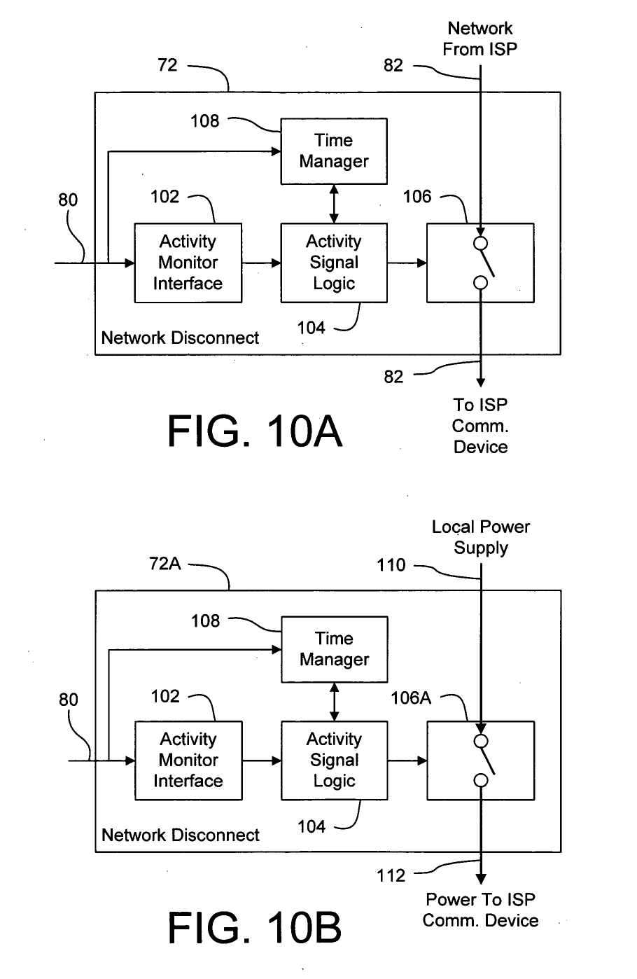

Note also that, even though network disconnect 72 is shown in the path of network connection 80 in FIG. 7, it is not necessary in all embodiments for network disconnect 72 to be physically inserted into the physical layer of the network. For example, as shown and described below with respect to FIG. 10B, in one embodiment network disconnect 72 terminates the connection between ISP 78 and ISP communication device 74 by powering down ISP communication device 74. Thus, network disconnect 72 represents any device capable of terminating the network connection between ISP communication device 74 and ISP 78 by any means including, but not limited to, switching the physical network media and/or controlling ISP communications device 74 responsive to indicia of activity of computer 76.

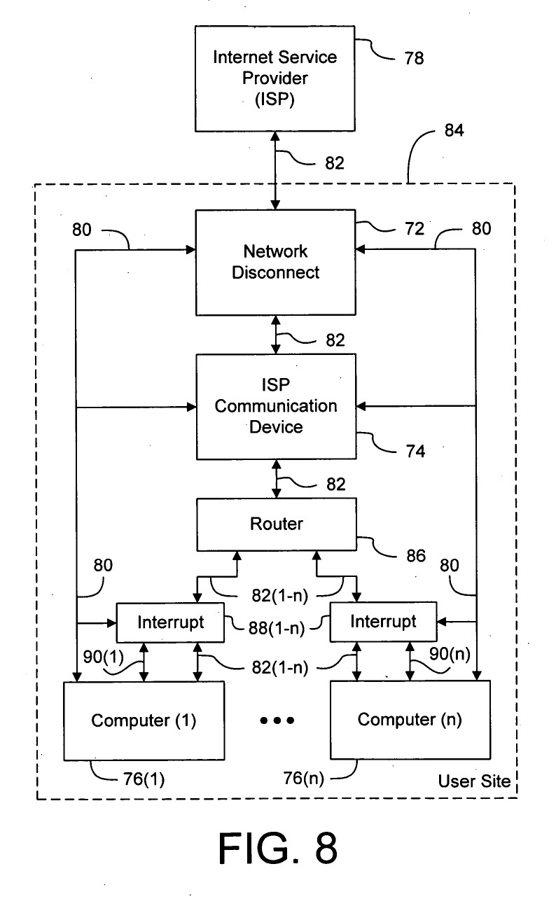

FIG. 8 is a block diagram of an alternate internet connection system 84. System 84 is similar to system 70 of FIG. 7, except that system 84 is modified to provide internet access to a plurality of computers 76(1-n) via ISP communication device 74 and ISP 78. In particular, a router 86 interconnects computers 76(1-n) and ISP communication device 74 to form a local area network. In this particular embodiment, computers 76(1-n) are coupled to router 86 through a respective one of a plurality of interrupt devices 88(1-n).

Because any one or more of computers 76 may be accessing internet resources at any given time, network disconnect 72 monitors the activity of all of computers 76(1-n) and terminates the connection with ISP 78 only if all of computers 76(1-n) are in a state of inactivity. Network disconnect 72 should not terminate network connection 82 with ISP 78 if any one of computers 76(1-n) are using network connection 82. However, when all of computers 76(1-n) are inactive and/or not using network connection 82, then network disconnect 72 will terminate the connection with ISP 78, thereby allowing ISP 78 to reassign the dynamic IP address previously assigned to ISP communication device 74 to another customer.

Each of interrupt devices 88(1-n) are similar to computer protection device 10, except that interrupt devices 88(1-n) are modified to generate an activity signal indicative of a particular activity level of an associated one of computers 76(1-n). For example, interrupt device 88(1) monitors the power drawn via power cord 90(1) by computer 76(1) and interrupts network connection 82(1) if the power drawn falls below a predetermined level. In addition to interrupting network connection 82(1), interrupt 88(1) provides an activity signal via connection 80 to network disconnect 72 indicating that computer 76(1) is inactive.

Optionally, computer 76(1) monitors its own activity level (e.g., by any of the methods described above), and provides an activity signal to both interrupt 88(1) and network disconnect 72 via connection 80. In the alternate embodiment, it is unnecessary for interrupt 88(1) to monitor power consumption by computer 76(1) and it is, therefore, unnecessary for power cord 90(1) to connect through interrupt 88(1). It is also unnecessary in this embodiment for interrupt 88(1) to provide an activity signal to network disconnect 72.

In view of the foregoing description, it should be clear that any of computers 76(1-n) that are in an inactive state will be isolated from network connection 82, even if other of computers 76(1-n) remain active and connected to ISP 78. When all of computers 76(1-n) are inactive, network disconnect 72 will terminate the connection with ISP 78. Because interrupts 88(1-n) will then have isolated computers 76(1-n) from network connection 82, termination of the connection with ISP 78 is not necessary to protect computers 76(1-n). However, terminating the connection with ISP 78 will provide the above-described advantage of releasing the IP address assigned to ISP communications device 74.

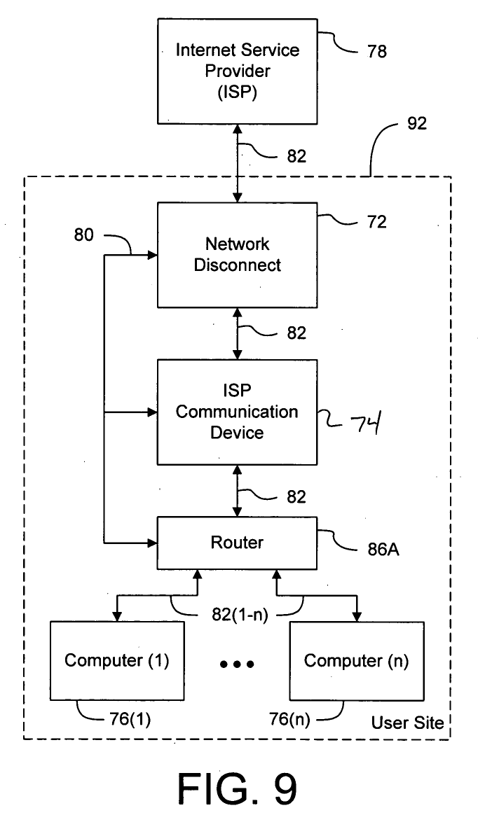

FIG. 9 is a block diagram of yet another system 92 for providing internet access to the plurality of computers 76(1-n). System 92 is similar to system 84 of FIG. 8, except that network activity of computers 76(1-n) is monitored by an alternate router 86A, which provides a signal to network disconnect 72, via connection 80, indicative of whether any of computers 76(1-n) have an active network connection. If none of computers 76(1-n) have an active network connection, then network disconnect will terminate the connection between ISP 78 and ISP communication device 74.

Because the network activity of computers 76(1-n) is monitored by alternate router 86A, it is not necessary for connection 80 to be extended to computers 76(1-n), nor is it necessary for interrupt devices 88(1-n) to monitor activity of computers 76(1-n) and/or to provide an activity signal to network disconnect 72. Therefore, interrupt devices 88(1-n) are omitted from system 92. It should be understood, however, that a protection device such as personal computer protection device 10 could still be used with any or all of computers 76(1-n) in system 92.

FIG. 10A is a block diagram showing one example of network disconnect 72 in greater detail to include an activity monitor interface 102, activity signal logic 104, network media relay 106, and time manager 108. Activity monitor interface 102 is operative to convert activity signals received via connection 80 into a format usable by activity signal logic 104. Activity signal logic 104, responsive to the activity signal from activity monitor interface 102 and a time signal from time manager 108, provides a control signal to network media relay 106. Depending on the value of the control signal, relay 106 is operative to either connect or break the physical layer network connection between ISP 78 and ISP communication device 74.

Time manager 108 is a user programmable timer that facilitates the imposition of time constraints on the connection between ISP 78 and ISP communication device 74, which can be useful, for example, in exercising parental control over a home network or limiting connectivity of an office network after normal working hours. For example, time manager 108 could be programmed to allow a connection with ISP 78 between the hours of 7:00 AM and 9:00PM, but to disallow a connection with ISP 78 at all other times. As another example, time manager could be programmed to allow a connection for only a limited amount of time during a given time period (e.g., four hours per day) to ensure that a child does not spend too much time on the internet.

A user can program time manager 108 in any number of ways. For example, time manager 108 could be programmed via software on one of computers 76(1-n) over connection 80. As another example, network disconnect 72 can include a separate user interface (not shown) to program time manager 108. In either case, it is anticipated that programming access be limited to authorized users, for example by use of passwords or some other security measure.

FIG. 10B is a block diagram of an alternate network disconnect 72A. Network disconnect 72A is similar to network disconnect 72, except that network disconnect does not interrupt the physical network layer between ISP 78 and ISP communication device 74. Instead, network disconnect 72A interrupts the power supply to ISP communication device 74, which results in the termination of communication between ISP communication device 74 and ISP 78 (e.g., the network connection times out), thereby releasing the IP address assigned to ISP communication device 74.

Network disconnect 72A includes a power input 110 (e.g., a standard AC power cord) adapted to draw power from a local power supply (e.g., a standard AC outlet), a power outlet 112 (e.g., a standard AC outlet), and a power switch 106A connected therebetween. Various devices can be used for power switch 106A including, but not limited to, an electro mechanical relay, a power semiconductor device, and so on.

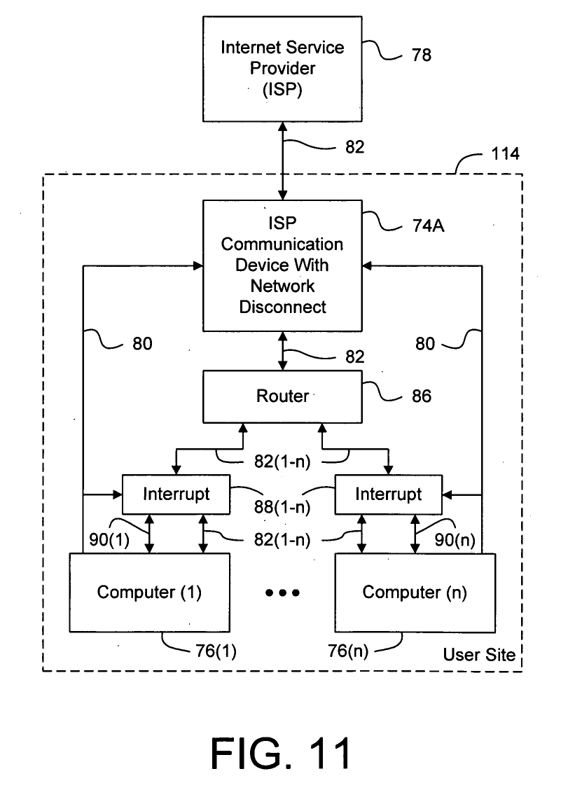

FIG. 11 is a block diagram of yet another system 114 for connecting a plurality of computers 76(1-n) to an internet. System 114 is similar to system 84 (FIG. 8), except that network disconnect 72 and ISP communication device 74 are replaced by an ISP communication device 74A with integrated network disconnect capabilities. In particular, ISP communication device 74A, responsive to activity signals on connection 80, can terminate a connection with ISP 78 via communication protocol programming (e.g., TCP/IP commands). The communication protocol programming can be embodied in software, firmware, hardware, or any combination thereof.

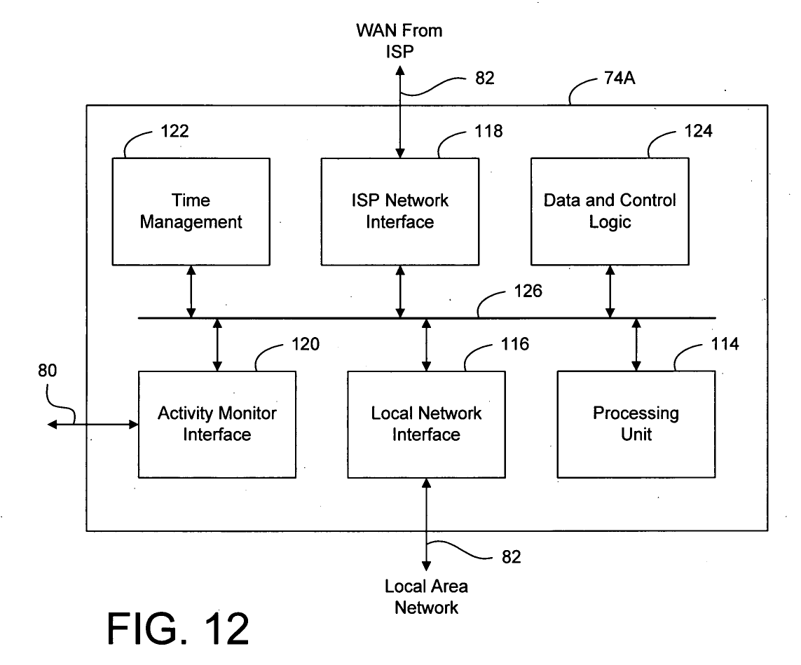

FIG. 12 is a block diagram showing ISP communication device 78 in greater detail to include one or more processing units 114, a local network interface 116, an ISP network interface 118, an activity monitor interface 120, a time management module 122, and data and control logic module 124, all intercommunicating via a bus 126. Processing unit 114 imparts functionality to ISP communication device 74A by executing data and code provided by the other modules and interfaces. Local network interface 116 facilitates communication with the LAN including router 86 and computers 76(1-n). ISP network interface 118 facilitates communication with ISP 78 over a wide area network (WAN). Activity monitor interface 120 facilitates communication with computers 76(1-n) and/or interrupts 88(1-n) via connection 80. Time management module 122 is a programmable module that facilitates the imposition of time constraints on the connection between ISP 78 and ISP communication device 74A, as described above with reference to time manager 108 of FIG. 10A. Data and control logic 124 provides overall control and coordination of ISP communication device 74A, including establishing and terminating connections with ISP 78 depending on the value of activity signals received via activity monitor interface 120 and settings stored in time management module 122. Data and control logic 124 can be programmed to establish and/or terminate a connection with ISP 78 based on any predetermined indicia of activity of computers 76(1-n) and/or time management settings stored in time management module 122.

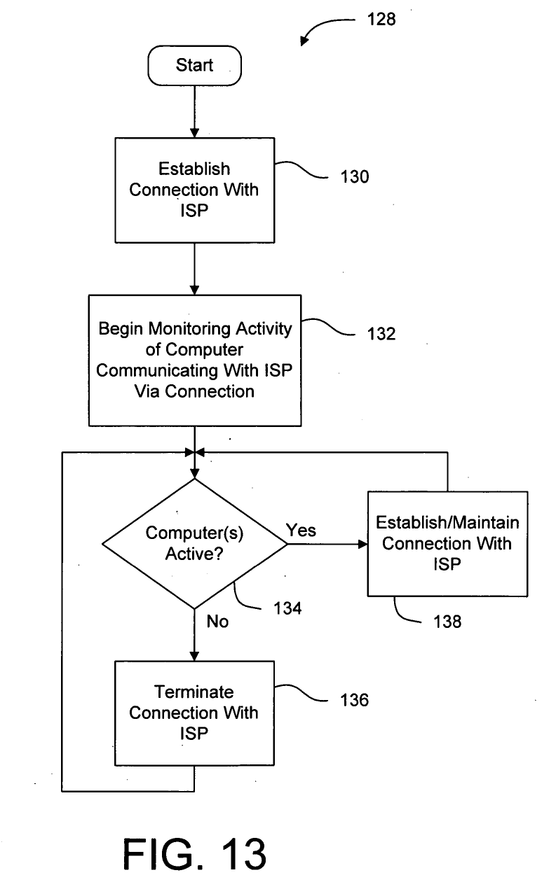

FIG. 13 is a flow chart summarizing one method 128 for protecting a computer. Method 128 will be described with reference to particular components described herein for the sake of clarity. However, it should be understood that method 128, as well as other methods described herein, is not limited to any particular physical structure. To the contrary, it is anticipated that the methods of the present invention can be carried out using a great variety of components and combinations of components. It should be further understood that computer readable media having code embodied therein for causing an electronic device to perform any of the methods of the present invention are considered to also be within the scope of the present invention.

According to method 128, in a first step 130, a ISP communication device 74, 74A establishes a connection 82 with ISP 78. Then, in a second step 132, network disconnect 72 or ISP communication device 74A begins monitoring the activity of one or more computers 76(1-n) communicating with ISP 78 via the established connection 82. Next, in a third step 134, network disconnect 72 or ISP communication device 74A determines whether the monitored computer(s) 76(1-n) continue to be active. If computers 76(1-n) have become inactive, then in a fourth step 136 network disconnect 72 or ISP communication device 74A terminates the connection with ISP 78 and method 128 returns to third step 134 to continue monitoring the activity level of computers 76(1-n). If, in third step 134, it had been determined that one or more of computers 76(1-n) had remained active, then in a fifth step 138 network disconnect 72 or ISP communication device 74A would have maintained the connection with ISP 78. Similarly, if after terminating the connection 82 with ISP 78 in fourth step 136 network disconnect 72 or ISP communication device 74A determines that one or more of computers 76(n) have become active again, then in fifth step 138 network disconnect 72 or ISP communication device 74A would cause network connection 82 to be reestablished.

The description of particular embodiments of the present invention is now complete. It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

We claim:

1. A computer protection device comprising:
a computer activity monitor for monitoring an activity level of at least one personal computer and generating an activity signal indicative of said activity level; and
an interrupt mechanism operative to terminate a connection with an internet service provider responsive to a particular value of said activity signal.

2. A computer protection device according to claim 1, wherein said interrupt mechanism is incorporated in a network communications device.

3. A computer protection device according to claim 2, wherein said network communications device is a DSL modem.

4. A computer protection device according to claim 2, wherein said network communications device is a cable modem.

5. A computer protection device according to claim 2, wherein said interrupt mechanism includes executable code operative to selectively terminate a connection with said internet service provider depending on said activity signal.

6. A computer protection device according to claim 2, wherein termination of said connection with said internet service provider facilitates the release of an address assigned to said network communications device by said internet service provider.

7. A computer protection device according to claim 1, wherein said interrupt mechanism includes:
a first network connector for connecting to said internet service provider;
a second network connector for connecting to an internet service provider communication device; and
a switch selectively connecting said first network connector and said second network connector depending on said activity signal.

8. A computer protection device according to claim 1, wherein said interrupt mechanism includes:
a power outlet for providing power to an internet service provider communications device; and
a switch operative to selectively disable said power outlet depending on said activity signal.

9. A computer protection device according to claim 1, wherein said activity monitor is operative to determine an amount of power being used by said personal computer.

10. A computer protection device according to claim 1, wherein said activity monitor determines said activity level of said personal computer by monitoring at least one network connection with said personal computer.

11. A computer protection device according to claim 1, wherein said activity monitor is incorporated in a network communications device.

12. A computer protection device according to claim 11, wherein said network communications device is a DSL modem.

13. A computer protection device according to claim 11, wherein said network communications device is a cable modem.

14. A computer protection device according to claim 11, wherein said interrupt mechanism is incorporated in said network communications device.

15. A computer protection device according to claim 1, wherein said activity monitor is operative to receive an indication from said computer that said computer has entered a low power mode.

16. A computer protection device according to claim 1, wherein said activity monitor includes:
a first portion separate disposed separately from said interrupt mechanism; and
a second portion incorporated in said computer protection device with said interrupt mechanism.

17. A computer protection device according to claim 16, wherein said first portion of said activity monitor is resident on said personal computer and is operative to transmit indicia of activity of said personal computer to said second portion of said activity monitor.

18. A computer protection device according to claim 16, wherein said first portion of said activity monitor is resident on an external device coupled to said personal computer and is operative to transmit indicia of activity of said personal computer to said second portion of said activity monitor.

19. A computer protection device according to claim 1, wherein said activity monitor monitors the respective activity levels of a plurality of personal computers.

20. A computer protection device according to claim 19, wherein said activity monitor generates said activity signal based on the activity levels of all monitored computers.

21. A computer protection device according to claim 19, wherein said activity monitor is incorporated in a network hub.

22. A computer protection device according to claim 19, wherein said activity monitor is incorporated in a network router.

23. A computer according to claim 1, further including a programmable time management device operative to selectively limit the time during which said connection with said internet service provider can be maintained.

24. A computer protection device according to claim 23, wherein said programmable time management device limits said connection to specified times of day.

25. A computer protection device according to claim 23, wherein said programmable time management device limits said connection to a specified maximum amount of time.

26. An internet connection system comprising:
a network connection to an internet service provider;
a network communication device operative to communicate with said internet service provider via said network connection;
at least one personal computer capable of communicating with said internet service provider via said network communication device; and
a network disconnect operative to selectively terminate a connection between said network communication device and said internet service provider responsive to an activity level of said personal computer.

27. An internet connection system according to claim 26, wherein said network communication device is a DSL modem or a cable modem.

28. An internet connection system according to claim 26, wherein said network disconnect is combined with said network communication device in a single component.

29. An internet connection system according to claim 26, wherein said network disconnect is operative to disconnect a physical network connection between the network communication device and the internet service provider.

30. An internet connection system according to claim 26, wherein:
said network disconnect is embodied in said network communication device; and
said connection with said internet service provider is terminated via communication protocol programming.

31. An internet connection system according to claim 26, further comprising a router disposed between said network communications device and said personal computer, said router being operative to provide an activity signal to said network disconnect based on network traffic from said personal computer.

32. An internet connection system according to claim 31, further comprising:
a second personal computer connected to said router; and
wherein said activity signal depends on network traffic from both said personal computer and said second personal computer.

33. An internet connection system according to claim 26, further comprising a timer communicating with said network disconnect to facilitate the imposition of time restrictions on said connection with said internet service provider.

34. An internet connection system comprising:
a wide area network for communicating with an internet service provider;
a local area network including a plurality of personal computers and a communication device providing communication with said internet service provider via said wide area network; and
means for disconnecting said local area network from said wide area network when said personal computers are inactive.

35. A method for protecting a computer comprising:
establishing a network connection with an internet service provider;
monitoring activity of at least one personal computer communicating with said internet service provider via said network connection; and
terminating said connection with said internet service provider if said personal computer becomes inactive.

36. A computer-readable medium having executable code embodied therein for causing an electronic device to perform the method of claim 35.
